(19) United States
(12) Patent Application Publication
(10) Pub. No.: US 2010/0072869 A1
(43) Pub. Date: Mar. 25, 2010

(54) CABINET AND CABLE CHAIN THEREOF

(75) Inventors: Yung-Chin Hsu, Taipei City (TW); Wei-Shih Chen, Taipei City (TW); Chi-Chun Yang, Taipei City (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/389,386

(22) Filed: Feb. 20, 2009

(30) Foreign Application Priority Data
Sep. 25, 2008 (TW) 97136952

(51) Int. Cl. A47B 88/00; F16G 13/00

(52) U.S. Cl. 312/348.3; 59/78

(57) ABSTRACT

A cable chain includes clockwise sections and counter-clockwise sections alternatively arranged and connected in series. Each clockwise section has concatenated clockwise chain monomers, wherein an included angle between each two clockwise chain monomers is limited from 0 degree to 180 degrees. Each counter-clockwise section has concatenated counter-clockwise chain monomers, wherein the included angle between each two counter-clockwise chain monomers is limited from 180 degrees to 360 degrees. Therefore, the cable chain may be bent back and forth like a letter W.

### RELATED APPLICATIONS

This application claims priority to Taiwan Application Serial Number 97136952, filed Sep. 25, 2008, which is herein incorporated by reference.

### BACKGROUND

1. Field of Invention

The present invention relates to a cabinet for electronic devices. More particularly, the present invention relates to a cable protecting and storing module.

2. Description of Related Art

A cabinet for large server may contain a lot of electronic devices like hard discs, video disc players, processors, and fans. The cabinet may have connectors disposed thereon to electrically connect the electronic devices and a power supply to electrically connect the electronic devices and a print circuit board.

The connectors in the cabinet are often designed to be hot swappable or hot pluggable, which means the ability to remove electronic devices from the server without rebooting while it is operating. The cabinet is usually designed to have a large chassis with many drawers to contain electronic devices, and connectors disposed on the drawers to connect the electronic devices and a circuit board fixed in the chassis. When the drawers are pulled out of the chassis, the connectors and the circuit board may be disconnected, and therefore power supplying and data communication of the electronic devices may stop.

However, sometimes the drawer is pulled out of the chassis to check if the electronic device is well functioned, instead of to replace the electronic device. Disconnecting the electronic device repeatedly during operating may interact the operating server, stop calculation, and furthermore damage the server and the electronic device.

To solve the above problem, a cable may be added to connect the connector and the circuit board. Since the cable is flexible, it may bend or stretch when the drawer is pushed in or pulled out of the chassis, and the connection between the connector and the circuit board may not be cut off.

The cable must be long enough to allow the entire drawer pulled out of the chassis, which may cause problems to store the cable. Specifically, when the drawer is pushed into the chassis, the cable may be bent to interpose between the drawer and the chassis to stop the drawer moving, or may press the electronic devices or electronic components of the server nearby, or may be winded around.

Therefore, a new cable protecting module and a cabinet thereof to limit the route of the cable when it stretches or bends is needed.

### SUMMARY

A cable chain may limit a route of a cable during stretching or bending, which may protect the cable and electronic components of a server nearby from being hit.

The cable chain has a plurality of clockwise sections and a plurality of counter-clockwise sections alternatively arranged and connected in a series. A cable may be stored in the cable chain and may stretch or bend with the cable chain.

Each clockwise section has a plurality of concatenated clockwise chain monomers, which means the clockwise chain monomers series connecting each other. An included angle between each two immediately-connected clockwise chain monomers is limited in a range of 0 degree to 180 degrees. Please notice that the included angle is a vectorial angle. Therefore, the clockwise section may only bend clockwise.

Each counter-clockwise section has a plurality of concatenated counter-clockwise chain monomers, which means the counter-clockwise chain monomers are series connecting each other. An included angle between each two immediately-connected counter-clockwise chain monomers is limited in a range of 180 degrees to 360 degrees, such that the counter-clockwise section may only bend counter-clockwise.

Because the clockwise sections and counter-clockwise sections are alternatively arranged, the cable chain may bend back and forth like a letter W, which may limit the position and the rouge of the cable in the cable chain.

This invention also provides another cable chain with limited degrees of freedom. The cable chain has a plurality of clockwise chain monomers and a plurality of counter-clockwise chain monomers.

The clockwise chain monomers are concatenated to form a plurality of clockwise sections. An included angle between each two immediately-connected clockwise chain monomers is limited in a range of 0 degree to 180 degrees, which allows the clockwise section to only bend clockwise.

The counter-clockwise chain monomers are concatenated to form a plurality of counter-clockwise sections and at least a lengthening section. An included angle between each two connected counter-clockwise chain monomers is limited in a range of 180 degrees to 360 degrees. Therefore, the counter-clockwise section and the lengthening section may bend counterclockwise only.

The lengthening section is series connected to one of the clockwise sections, and the clockwise sections and the counter-clockwise sections are alternatively arranged and connected in a series. When the cable chain bends, it may bend back and forth due to the alternative arrangement of the clockwise sections and the counter-clockwise sections.

This invention discloses a cabinet to limit the rouge of the cable during bending. The cabinet has a chassis, a drawer, a box and the cable chain. The chassis has a slide, and the drawer is connected the chassis via the slide. A box is fastened on the drawer, wherein the box has a pair of opposite sidewalls.

As the above, the cable chain has clockwise sections and counter-clockwise sections alternatively arranged and connected in a series, wherein each clockwise section has series connected clockwise chain monomers and each counter-clockwise section has series connected counter-clockwise chain monomers.

Both the clockwise chain monomer and the counter-clockwise chain monomer have a through hole penetrated thereof. The through holes join each other to form a continuous tube.

An end of the cable chain is fastened on the chassis, and the other end of the cable chain is fastened on the box, and part of the cable chain is located between the opposite sidewalls of the box.

When the drawer slides forward to the chassis along the slide, the box may push the cable chain to move and bend. Because the cable chain is engaged by the box, it may bend between the opposite sidewalls.

The cable chain may limit the shape of the cable after bent. The box may further limit the position of the bent cable chain therein to keep the cable away from the electronic components nearby.

Additionally, this invention provides another cabinet. The cabinet has a chassis, a drawer, a box and a cable chain. The chassis has a slide, and the drawer is connected the chassis via the slide. A box is fastened on the drawer, and has a pair of opposite sidewalls.

The cable chain has clockwise sections, counter-clockwise sections, and a lengthening section, which has a plurality of concatenated chain monomers, The clockwise sections and the counter-clockwise sections are alternatively arranged and connected in a series, and the lengthening section is series connected one of the clockwise sections.

The lengthening section is located at an end of the cable chain, and is fastened on the chassis. The other end of the cable chain is either one of the clockwise sections or one of the counter-clockwise sections, and is fastened on the box.

When the drawer slides forward to the chassis along the slide, part of the cable chain may be engaged by the box, and may be bent between the opposite sidewalls of the box.

This invention also provides another cabinet to contain electronic devices and cables. The cabinet may limit the bending rouge and the position of the cable to prevent the cable pressing other components around.

The cabinet has a chassis with a slide, a drawer connected the chassis via the slide, a box fastened on the drawer with a pair of opposite sidewalls, and a cable chain.

The cable chain has clockwise chain monomers and counter-clockwise chain monomers. The clockwise chain monomers are concatenated to form at least one clockwise section, wherein an included angle between each two immediately-connected clockwise chain monomers is limited in a range of 0 degree to 180 degrees. The counter-clockwise chain monomers are concatenated to form at least one counter-clockwise section and at least a lengthening section, wherein an included angle between each two immediately-connected counter-clockwise chain monomers is limited in a range of 180 degrees to 360 degrees.

In an embodiment of this invention, the cable chain has a lengthening section, a counter-clockwise chain section, and a clockwise chain section. The lengthening section is fastened on the chassis, and the counter-clockwise section is fastened on the drawer, and the clockwise section interposes between and series connected to the lengthening section and the counter-clockwise section.

When the drawer slides forward to the chassis along the slide, the cable chain is engaged by the box to be bent back and forth between the sidewalls.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a three-dimensional view of a cable chain according to one embodiment of this invention;

FIG. 2A is a three-dimensional view of the clockwise section shown in FIG. 1;

FIG. 2B is a top view of the clockwise section shown in FIG. 2A;

FIG. 3A is a three-dimensional view of the clockwise section shown in FIG. 1;

FIG. 3B is a top view of the clockwise section shown in FIG. 3A;

FIG. 4 is a three-dimensional view of a cable chain according to another embodiment of this invention,

FIG. 5A is a three-dimensional view of a cabinet according to another embodiment of this invention; and

FIG. 5B is a three-dimensional view of the cabinet shown in FIG. 5A.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

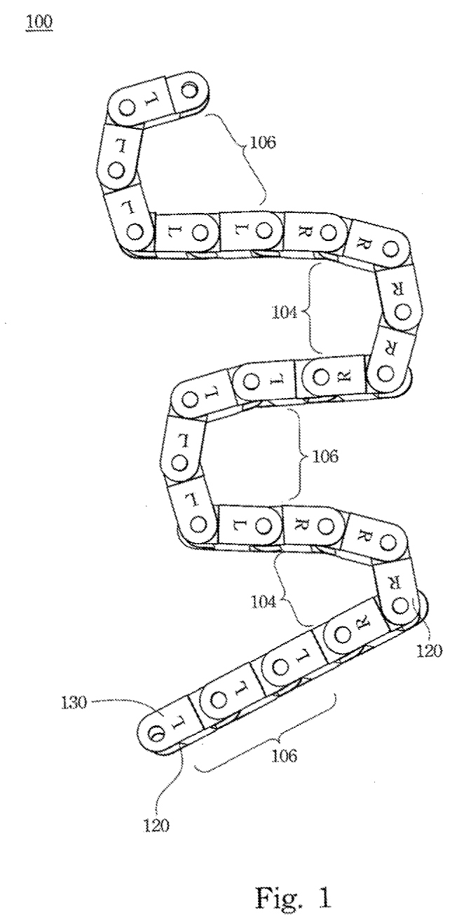

Please refer to FIG. 1. FIG. 1 is a three-dimensional view of a cable chain 100 according to one embodiment of this invention. The cable chain 100 has many chain monomers series connected each other. The monomer may rotate around the connected monomer, and therefore the cable chain 100 may bend or turn. A cable may be stored in the cable chain and may stretch or bend with the cable chain.

In the embodiment of this inventions the cable chain 100 includes clockwise sections 104 and counter-clockwise sections 106 alternatively arranged and connected in a series.

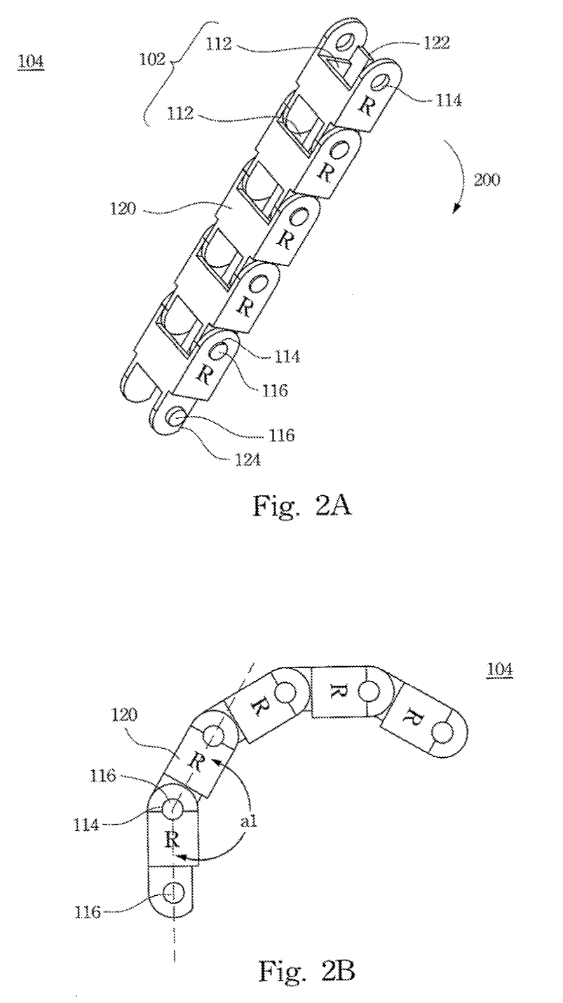

Please refer to FIG. 1, FIG. 2A and FIG. 2B at the same time. FIG. 2A is a three-dimensional view of the clockwise section 104, and FIG. 28 is a top view of the clockwise section 104.

Each clockwise section 104 has many concatenated clockwise chain monomers 120, which means the clockwise chain monomers 120 are series connecting each other. Please notice that the types and shapes of the clockwise chain monomer 120 are many, and the connection of the clockwise chain monomers 120 may change as well, Although a type of clockwise chain monomers 120 is demonstrated in this specification as an example, it does not limit the scope of this invention.

In the embodiment of this invention, each clockwise chain monomer 120 has a through hole 112 penetrated thereof to allow cables passing through. The clockwise chain monomer 120 further has a joining hole 114 and a joining axis 116 separately disposed on two openings of the through hole 112. One clockwise chain monomer 120 may use the joining hole 114 to pivot on the joining axis 116 of another clockwise chain monomer 120, and therefore those two clockwise chain monomers 120 may be series connected.

The clockwise chain monomer 120 may connect another clockwise chain monomer 120 via its own joining axis 116 and may rotate around the joining axis 116 clockwise which means the clockwise chain monomer 120 may rotate around the connected clockwise chain monomer 120 clockwise. Specifically, a first included angle a1 between each two immediately-connected clockwise chain monomers 120 is limited in a range of 0 degree to 180 degrees, wherein the first included angle a1 is a vectorial angle. The first included angle a1 may be limited to be between 60 degrees and 180 degrees. In the embodiment of this invention, the first included angle a1 is between 90 degrees and 180 degrees.

Therefore, only two situations may happen. In one situation, the two connected clockwise chain monomers 120 may line up, which means the first included angle a1 is equal to 180 degrees. In the other, the clockwise chain monomer 120 may rotate clockwise around the connected clockwise chain monomer 120, which is connected via joining axis 116 thereof. In other words, the clockwise section 104 may only bend clockwise, not counter-clockwise.

The clockwise chain monomer 120 has stoppers disposed thereof to stop the clockwise section 104 from bending counter-clockwise. Many different kinds of structure may be used to complete the above limitation. Stoppers described are used as an example, and should not limit the scope of this invention. In the embodiment of this invention, a first stopper 122 and a second stopper 124 are disposed separately on two opposite openings of the through hole 112. The second stopper 124 is fastened on the clockwise chain monomer 120 and may move with the clockwise chain monomer 120 when rotating. The first stopper 122 is a block located in a path of the second stopper 124 of the connected clockwise chain monomer 120 when the second stopper 124 moves counter-clockwise with the connected clockwise chain monomer 120. In the embodiment, when the first included angle a1 is equal to 180 degrees, the first stopper 122 may touch the second stopper 124 and stop the second stopper 124 from moving forward.

Additionally, when the clockwise chain monomers 120 are concatenated, the through holes 112 of every clockwise chain monomers 120 may join each other to form a continuous tube 102. The continuous tube 102 may be used to contain cables.

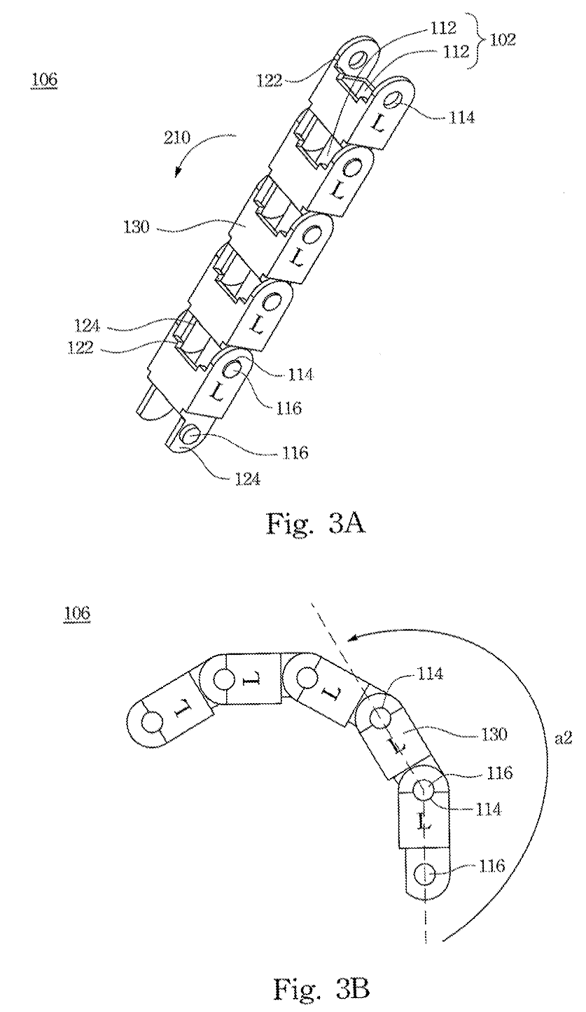

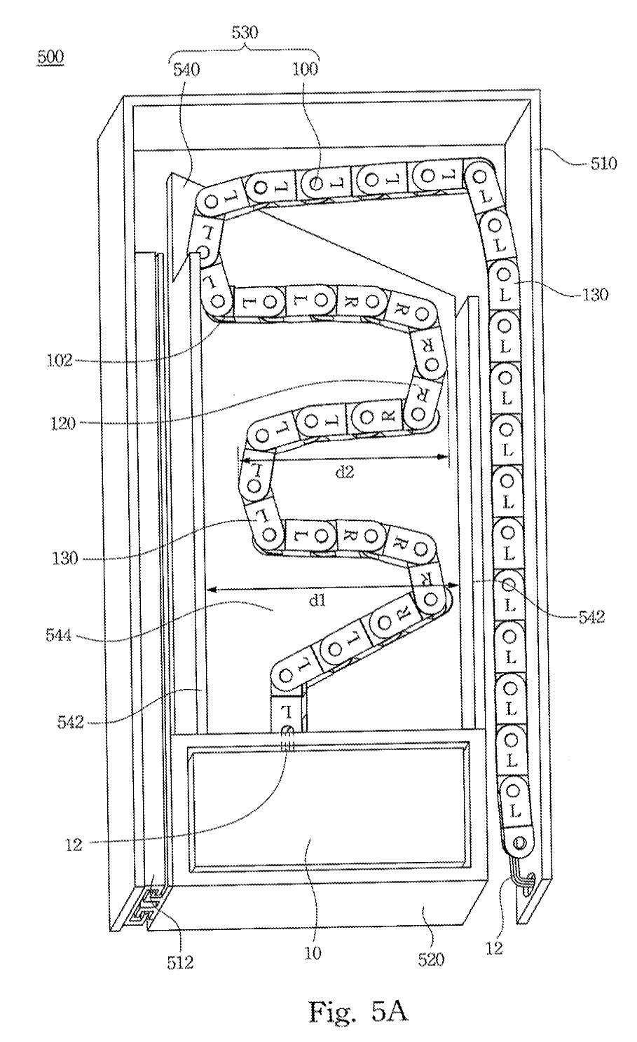

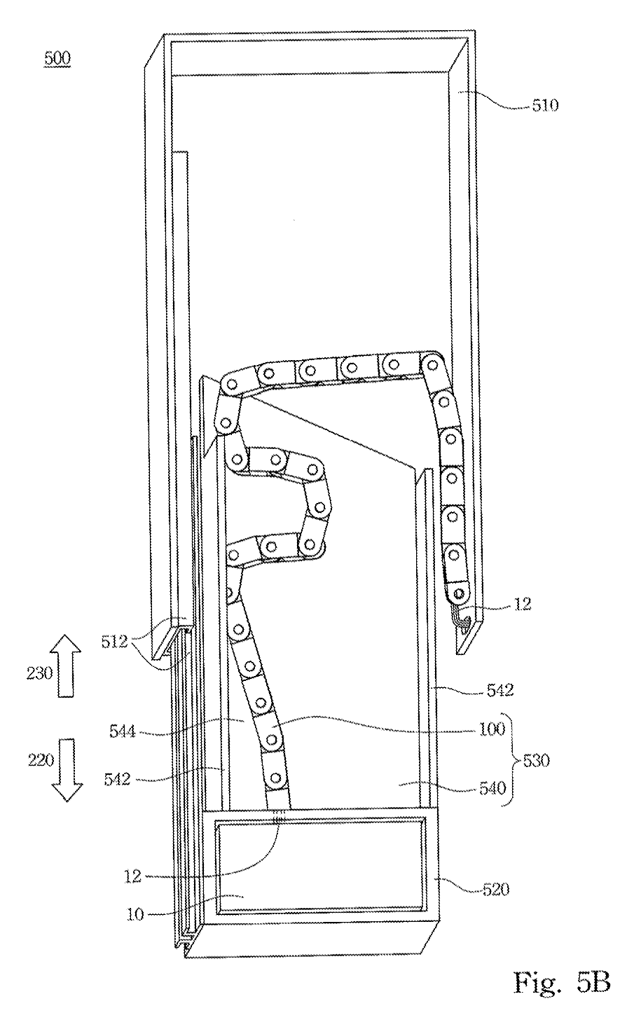

Please refer to FIG. 1, FIG. 3A and FIG. 3B at the same time. FIG. 5A is a three-dimensional view of the counter-clockwise section 106, and FIG. 3B is a top view of the counter-clockwise section 106.

Each counter-clockwise section 106 has many concatenated counter-clockwise chain monomers 130, which means the counter-clockwise chain monomers 130 are series connecting each other. Please notice that the types and shapes of the counter-clockwise chain monomer 130 are many, and the connection of the counter-clockwise chain monomers 130 may change as well. Although some counter-clockwise chain monomers 130 are demonstrated in this specification as an example, it does not limit the scope of this invention.

In the embodiment of this invention, each counter-clockwise chain monomer 130 has a through hole 112 penetrated thereof to allow cables passing through. The counter-clockwise chain monomer 130 further has a joining hole 114 and a joining axis 116 separately disposed on two openings of the through hole 112. One counter-clockwise chain monomer 130 may use the joining hole 114 to pivot on the joining axis 116 of another counter-clockwise chain monomer 130, and therefore those two counter-clockwise chain monomers 130 may be series connected.

The counter-clockwise chain monomer 130 may connect another counter-clockwise chain monomer 130 via its own joining axis 116 and may rotate around the joining axis 116 counter-clockwise, which means the counter-clockwise chain monomer 130 may rotate around the connected counter-clockwise chain monomer 130 counter-clockwise. Specifically, a second included angle a2 between each two immediately-connected counter-clockwise chain monomers 130 is limited in a range of 180 degrees to 360 degrees, wherein the second included angle a2 is a vectorial angle. The second included angle a2 may be limited to be between 180 degrees and 300 degrees. In the embodiment of this invention, the second included angle a2 is between 180 degrees and 270 degrees.

Therefore, only two situations may happen. In one situation, the two counter-connected clockwise chain monomers 130 may line up, which means the second included angle a2 is equal to 180 degrees. In the other, the counter-clockwise chain monomer 130 may rotate counter-clockwise around the connected counter-clockwise chain monomer 130, which is connected via joining axis 116 thereof. In other words, the counter-clockwise section 106 may only bend counter-clockwise, not clockwise.

To achieve the above limitation, the counter-clockwise chain monomer 130 has stoppers disposed thereof. In the embodiment of this invention, a first stopper 122 and a second stopper 124 are disposed separately on two opposite opening of the through hole 112 of each counter-clockwise chain monomer 130. The second stopper 124 is fastened on the counter-clockwise chain monomer 130 and may move with the counter-clockwise chain monomer 130 when it is rotating. The first stopper 122 is a block located in a path of the second stopper 124 of the connected counter-clockwise chain monomer 130 when the second stopper 124 moves clockwise with the connected counter-clockwise chain monomer 130. In the embodiment, when the second included angle a2 is equal to 180 degrees, the first stopper 122 may touch the second stopper 124 and stop the second stopper 124 from moving forward. Please notice that stoppers described are used as an example, and should not limit the scope of this invention. In fact, many different kinds of structures may be used to complete the above limitation.

Additionally, when the counter-clockwise chain monomers 130 are concatenated, the through holes 112 of every counter-clockwise chain monomer 130 may join each other to form a continuous tube 102 to contain cables.

The cable chain 100 shown in FIG. 1 has a plurality of clockwise sections 104 and a plurality of counter-clockwise sections 106 alternatively arranged and connected in a series, Because the clockwise sections 104 may only bend clockwise and the counter-clockwise sections 106 may only bend counter-clockwise, the cable chain 100 may bend back and forth like a letter W.

The clockwise sections 104 are series connected to the counter-clockwise sections 106, and the through holes 112 thereof may join to form the continuous tube 102 to contain cables.

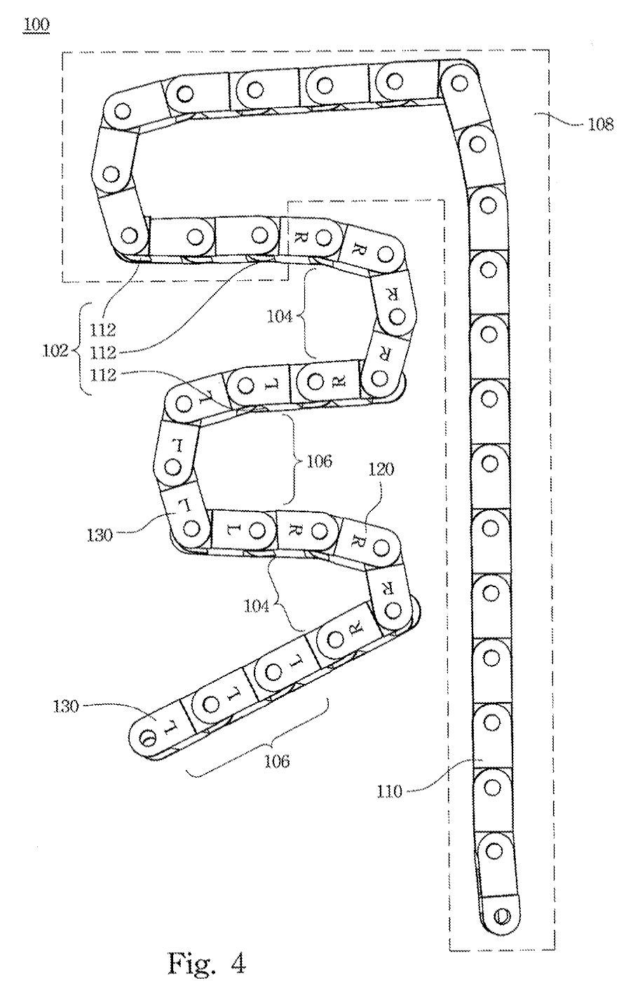

Please refer to FIG. 4. FIG. 4 is a three-dimensional view of a cable chain 100 according to another embodiment of this invention. The cable chain 100 further includes a lengthening section 108 to lengthen the cable chain 100, which may provide designers more possibility of the location of circuit board (not shown) or other connectors.

The lengthening section 108 has a plurality of concatenated chain monomers 110. The chain monomer 110 may rotate around the connected chain monomer 110 clockwise and/or counter-clockwise. Please notice that the types and shapes of the chain monomer 110 are many, and the connection of the monomers 110 may change as well. In one embodiment of this invention, the chain monomers 110 are counter-clockwise chain monomers 130. In another embodiment of this invention, the chain monomers 110 are clockwise chain monomers 120.

The number of the chain monomers 110 in the lengthening section 108 is larger than sum of the number of the clockwise chain monomers 120 of one clockwise section 104 and the number of the counter-clockwise chain monomers 130 of one counter-clockwise section 106. Therefore, the length of the lengthening section 108 is longer than the length of the clockwise section 104 and the counter-clockwise section 106.

In the embodiment of this invention, the number of the chain monomers 110 of the lengthening section 108 is larger than sum of the number of the clockwise chain monomers 120 and the number of the counter-clockwise chain monomers 130. In other words, the length of the lengthening section 108 is longer than the length of the clockwise sections 104 and the counter-clockwise sections 106.

Additionally, since the clockwise section 104, the counter-clockwise sections 106, and the lengthening section 108 are series connected, the through holes 112 thereof may join to form the continuous tube 102 to contain cables.

In the embodiment of this invention, an end of the lengthening section 108 is series connected to one of the clockwise sections 104, and the clockwise sections 104 are alternatively arranged and series connected to the counter-clockwise sections 106. Therefore, the lengthening section 108 is located at an end of the cable chain 100, and the other end of the cable chain 100 is either one of the clockwise sections 104 or one of the counter-clockwise sections 106.

As described above, the included angle between the connected clockwise chain monomers 120 is limited between 90 degrees and 180 degrees. It may take at least 3 clockwise chain monomers 120 to make a U turn. Accordingly, the number of the clockwise chain monomers 120 of each clockwise section 104 may not be less than 3. Similarly, the number of the counter-clockwise chain monomers 130 of each counter-clockwise section 106 may not be less than 3. Since the number of the chain monomers 110 of the lengthening section 108 is larger than the sum of a number of the clockwise chain monomers 120 of one clockwise section 104 and a number of the counter-clockwise chain monomers 130 of one counter-clockwise section 106. The number of the chain monomers 110 of the lengthening section 108 may not less than 6.

However, when too many clockwise chain monomers 120 are connected in one clockwise section 120, the clockwise section 120 may bend to form a circuit, which may press other sections. Therefore, the number of the chain monomers 110, the clockwise chain monomers 120, and the counter-clockwise chain monomers 130 may be limited in a range. In the embodiment, the number of the clockwise chain monomers 120 of each clockwise section 104 may not be more than 6, because the minimum included angle between the connected clockwise chain monomers 120 is 90 degrees. Similarly, the number of the counter-clockwise chain monomers 130 of each counter-clockwise section 106 may not be more than 6.

In the embodiment of this invention, the cables may contain in the continuous tube 102 of the cable chain 100. Specifically, the cable may pass through the through hole 112 of each chain monomers 110, clockwise chain monomers 120, and counter-clockwise chain monomers 130. An end of the cables may extend out of the end of the lengthening section 108 to connect electronic components of the server like a circuit board or a power supply. The other end of the cables may extend out of the other end of the cable chain 100, which is either the clockwise section 104 or the counter-clockwise section 106, to connect electronic devices.

The cable chain 100 may use the arrangement of the clockwise sections 104 and counter-clockwise sections 106 therefore to limit a route of a cable during stretching or bending, which may protect the cables and electronic components of the server nearby from being hit by the cables.

Please refer to FIG. 5A. FIG. 5A is a three-dimensional view of a cabinet 500 according to another embodiment of this invention. The cabinet 500 has a chassis 510 and a drawer 520. The chassis 510 has a slide 512 disposed therein, and the drawer 520 is connected to the chassis 510 via the slide 512.

Specifically, the slide 512 is fastened on an inner surface of the chassis 510 horizontally. The slide 512 connects an outside surface of the drawer 520. Therefore, the drawer 520 may slide horizontally forward or backward to the chassis 510 along the slide 512. The drawer 520 may be pushed to be stored inside the chassis 510, and may be pulled out of the chassis 510. Please notice that the types and shapes of the slide 512 are many. Although slide 512 is demonstrated in this specification as an example, it does not limit the scope of this invention.

The drawer 520 has a space therein to contain at least an electronic device 10. Some connectors (not shown) may be disposed in the drawer 520 to connect the electronic device 10 and electronic components of the server like a circuit board or power supply. In the embodiment of this invention, the connectors may connect the electronic device 10 and at least a cable 12, and the cable 12 may connect to the electronic components of the server out of the drawer 520.

The cabinet 500 further includes a cable-protecting module 530 to limit the rouge and the position of the cable 12 when stretching or bending. The cable-protecting module 530 has a box 540 fastened on the drawer 520 and a cable chain 100 having two ends separately connected to the chassis 510 and the box 540.

The box 540 has a bottom plate 544 and a pair of opposite sidewalls 542. In the embodiment of this invention, the sidewalls 542 are separately disposed on a pair of opposite sides of the bottom plate 544. The sidewalls are parallel to each.

In the embodiment of this invention, the sidewalls 542 of the box 540 are parallel to the slide 512, which means the sidewalls 542 are parallel to the moving path of the drawer 520.

The drawer 520 is fastened on one side of both sidewalls 542 and the bottom plate 544. The region on the bottom plate 544 between the other ends of both sidewalls 542 is free from any kinds of bumps, which means no bumps or walls are disposed on the bottom plate 544 between the other ends of both sidewalls 542 to block the cable chain 100.

In the embodiment of this invention, two ends of the cable chain 100 are separately fastened to the chassis 510 and the box 540. Specifically, one end of the cable chain 100 is fastened on the side of the box 540 immediately next to the drawer 520. More particularly, the end of the cable chain 100 is fastened on a corner surrounded by the sidewall 542, the bottom plate 544 and the drawer 120.

Obviously, part of the cable chain 100 may be located between the sidewalls 542 of the box 540. The sidewalls 542 may block the cable chain 100 from crossing over the sidewalls 542, and may keep the cable chain 100 inside the box 540. To achieve the above limitation, the height of the sidewalls 542 may be larger than a height that the cable chain 100 may bend. In the embodiment of this invention, the cable chain 100 may barely bend vertically, which means the height the cable chain 100 may bend is very small. The height of the sidewalls 542 may be about equal to or slightly larger than the height of the cable chain 150.

The monomers of the cable chain 100 may be monomers that can rotate clockwise and/or counter-clockwise. In the embodiment of this invention, the cable chain 100 has the clockwise sections 104 and the counter-clockwise sections 106 alternatively arranged and connected in a series as described above.

As the above, the cable chain 100 has a continuous tube 102 to contain cable 12. An end of the cable 12 may extend out of the end of cable chain 100 fastened on the chassis 510 to connect the electronic components of the server. The other end of the cable 12 may extend out of the end of cable chain 100 fastened on the box 540 to connect the electronic device 10. In another embodiment of this invention, the cable 12 may connect the electronic device 10 through connectors (not shown) disposed on the drawer 520.

Please refer to FIG. 5S and FIG. 5B at the same time. FIG. 5A shows that the drawer 520 is located inside the chassis 510. FIG. 5B shows that the drawer 520 is pulled out of the chassis 510.

The drawer 520 may move along the slide 512. The drawer 520 may be pulled out of the chassis 510 along a direction 220, or may be pushed backward into the chassis 510 along a direction 230.

When the drawer 520 is pushed out of the chassis 510, the box 540 may move with the drawer 520 and may bring the end of the cable chain 100 fastened on the box 540 along the direction 220. Since the other end of the cable chain 100 is fastened on the chassis 510, the entire cable chain 100 may not move, but stretch instead. Each monomers of the cable chain 100 like chain monomers 110, clockwise chain monomers 120, and counter-clockwise chain monomers 130 may rotate to change the shape of the cable chain 100, and furthermore to stretch the cable chain 100 as shown in FIG. 5b.

On the contrary, when the drawer 520 is pushed back to the chassis 510 along the slide 512, the box 540 may bring the end of the cable chain 100 fastened thereon to move with the drawer 520. Since the other end of the cable chain 100 is fastened on the chassis 510, the cable chain 100 may bend.

As described above, the sidewalls 542 of the box 540 may stop the cable chain 100 from crossing over, and hence the cable chain 100 may bend between the sidewalls 542.

In the embodiment of this invention, due to the arrangement of the clockwise sections 104 and the counter-clockwise sections 106 and the sidewalls 542 of the box 540, the cable chain 100 may bend back and forth between the sidewalls 542 in the box 540.

In the embodiment of this invention, the cable chain 100 further has a lengthening section 108. The lengthening section 108 has many concatenated counter-clockwise chain monomers 130. The number of the counter-clockwise chain monomers 130 of the lengthening section 108 is larger than the sum of the number of the clockwise chain monomers 120 of the clockwise sections 104 and the number of the counter-clockwise chain monomers 130 of the counter-clockwise sections 106.

One end of the lengthening section 108 is series connected to one of the clockwise sections 104, and the clockwise sections 104 are alternatively arranged and series connected to the counter-clockwise sections 106.

The end of the cable chain 100 fastened on the box 540 is either the clockwise section 104 or the counter-clockwise section 106, which may depend on the design of routing and the length of the cable chain 100.

The other end of the lengthening section 108 is fastened on the chassis 510. As described above, the lengthening section 108 may let the total length of the cable chain 100 be longer and may allow the designers to design the position of elements of the cabinet 500 freely. Therefore, in some situations, part of the lengthening section 108 may not be located in the box 540 when the cable chain 100 is bent as shown in FIG. 5A. Instead, the part of the lengthening section 108 may be located between the chassis 510 and the box 540. In the embodiment of this invention, the end of the lengthening section 108 is fastened on the chassis 510 near the drawer 520. Part of the lengthening section 108 may interpose between the box 540 and the chassis 510.

Additionally, a distance between the opposite sidewalls 542 of the box 540 may be designed according to the length of bent clockwise section 104 and counter-clockwise section 106 to allow the cable chain 100 bending in the box 540 smoothly. The clockwise section 104 and the connected counter-clockwise section 106 after bent may have a width d2. The opposite sidewalls 542 of the box 540 may a distance d1. The width d2 may about equal to or slightly smaller than the distance d1.

However the length d2 is uncertain because the included angles between the monomers are not unified. In the embodiment of this invention, the distance d1 may be designed according the length of the clockwise section 104 and the connected counter-clockwise section 106 when they are stretching in a line without bending. The length of the clockwise section 104 and the connected counter-clockwise section 106 is smaller than about twice of the distance d1. Therefore, the width d2 may be smaller than the distance d1.

In the foregoing, the cabinet 500 and the cable chain 100 this invention disclosed may protect the cable 12 from being damaged during pulling or pushing the drawer 520. The bending angle of the cable chain 100 may be limited to limit the rouge of the cable during stretching and/or bending. The box 540 may engage the cable chain 100 to bend therein. Therefore, the cable 12 may no longer press the electronic components nearby or interpose between the drawer 520 and the chassis 510 to stop the drawer 520 moving.

Although the present invention has been described in considerable detail with reference certain embodiments thereof other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cable chains comprising:
a plurality of clockwise chain monomers concatenated to form a plurality of clockwise sections, wherein an included angle between each two immediately-connected clockwise chain monomers consists of a range of 0 degree to 180 degrees, and
a plurality of counter-clockwise chain monomers concatenated to form a plurality of counter-clockwise sections and at least a lengthening sections wherein an included angle between each two immediately-connected counter-clockwise chain monomers consists of a range of 180 degrees to 360 degrees,
the lengthening section being series connected to one of the clockwise sections, and the clockwise sections and the counter-clockwise sections being alternatively arranged and connected in a series.

2. The cable chain of claim 1, wherein each of the clockwise chain monomers and the counter-clockwise chain monomers has a through hole penetrated thereof, and the through holes joining each other to form a continuous tube.

3. A cabinet, comprising:
a chassis having a slide;
a drawer connected the chassis via the slide;
a box fastened on the drawer, the box having a pair of opposite sidewalls; and
the cable chain according to claim 2 having two ends separately fastened on the chassis and the boxy and part of the cable chain being located between the opposite sidewalls of the box,
when the drawer slides forward the chassis along the slide, the cable chain being engaged by the box to be bent between the opposite sidewalls.

4. The cabinet of claim 3 wherein when the drawer slides forward to the chassis along the slide, the cable chain is engaged by the box to be bent back and forth between the opposite sidewalls.

5. The cabinet of claim 3, wherein a length of each clockwise section and one of the connected counter-clockwise section is shorter than twice of a distance between the opposite sidewalls.

6. The cabinet of claim 3, wherein the opposite sidewalls are parallel to the slide.

7. A cabinet, comprising:
a chassis having a slide;
a drawer connected the chassis via the slide;
a box fastened on the drawer, the box having a pair of opposite sidewalls, and
a cable chain comprising:
a plurality of clockwise chain monomers concatenated to form at least one clockwise section, wherein an included angle between each two immediately-connected clockwise chain monomers consists of a range of 0 degree to 180 degrees; and
a plurality of counter-clockwise chain monomers concatenated to form at least one counter-clockwise section and at least a lengthening section, wherein an included angle between each two immediately-connected counter-clockwise chain monomers consists of a range of 180 degrees to 360 degrees,
the lengthening section being fastened on the chassis, the counterclockwise section being fastened on the drawer and the clockwise section interposing between and being series connected to the lengthening section and the counter-clockwise section,
when the drawer sliding forward to the chassis along the slide, the cable chain being engaged by the box to be bent back and forth between the sidewalls.

8. The cabinet of claim 7, wherein each of the clockwise chain monomers and the counter-clockwise chain monomers has a through hole penetrated thereof, and the through holes joining each other to form a continuous tube.

9. The cabinet of claim 8, further comprising at least a cable disposed in the continuous tube.

10. The cabinet of claim 9, further comprising at least an electronic device located in the drawer and electrically connected to the cable.

11. The cabinet of claim 7, wherein part of the lengthening section interposes between the box and the chassis.

12. The cabinet of claim 7, wherein a number of the clockwise chain monomers is in a range of 3 to 6.

13. The cabinet of claim 7, wherein a number of the counter-clockwise chain monomers of the counter-clockwise section is in a range of 3 to 6.

14. The cabinet of claim 7, wherein the included angle between each two immediately-connected clockwise chain monomers consists of a range of 90 degrees to 180 degrees.

15. The cabinet of claim 7, wherein the included angle between each two immediately-connected counter-clockwise chain monomers consists of a range of 180 degrees to 270 degrees.
